(19) United States
(12) Patent Application Publication
(10) Pub. No.: US 2012/0109754 A1
(43) Pub. Date: May 3, 2012

(54) SPONSORED MULTI-MEDIA BLOGGING

(75) Inventors: Tao Mei, Beijing (CN); Xian-Sheng Hua, Beijing (CN); Ying-Qing Xu, Beijing (CN); Shipeng Li, Palo Alto, CA (US)

(73) Assignee: MICROSOFT CORPORATION, Redmond, WA (US)

(21) Appl. No.: 12/939,132

(22) Filed: Nov. 3, 2010

(51) Int. Cl. G06Q 30/00; G06F 15/16

(52) U.S. Cl. 705/14.64; 709/219; 705/14.49

(57) ABSTRACT

The sponsored multi-media blogging technique is an advertising-driven service on a computing device, such as a mobile phone, that makes the multi-media micro-blog or blog an effective carrier for advertising. The data collected while employing the sponsored multi-media blogging technique is used for user intent mining and increasing advertisement relevance for mobile advertising projects. The benefits to the sponsored multi-media blogging technique's users are a natural interface for composing multi-media micro-blogs/blogs and instant experience sharing, while the benefits to advertisers is the promoted brand impression from the contextual advertising in rich media micro-blogs/blogs.

### BACKGROUND

Since their introduction, social network sites (SNSs), such as, for example, MySpace™, Facebook®, Microsoft Corporation's Windows® Live Spaces, and Twitter® (the most popular micro-blog site), have attracted millions of users, many of whom have integrated these sites into their daily practices. There are hundreds of SNSs, with various technological capabilities, supporting a wide range of interests and involving millions of users and messages/blogs. Among the tremendous amount of users, more and more are using mobile phones to consume these services (such as instant messaging, blogging, and experience sharing) provided by the SNSs. This is because mobile phones have become the most natural platform for interaction and communication. Furthermore, it is expected that future instant messages or blogs will be multimodal, that is, users will be able to use different input methods (such as text, voice, photo, video, and even smell) to record and share their live experiences. The real time streaming and sharing of these multi-media instant messages or blogs over the SNSs will be a phenomenon in the near future. Therefore, the rich dataflow through the SNSs on mobile phones can be a kind of effective information carrier to provide advertising services.

However, the power of mobile phones as a carrier for advertising has not been well investigated. Current online advertising strategy is still dominated by display advertising and sponsored search, both of which are mainly deployed on desktop computers. However, compared with desktop devices, mobile phones are becoming more pervasive as they are cheaper and more portable.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The sponsored multi-media blogging technique described herein pertains to a method of streaming multi-media data or messages, for example, in the form of blogs or micro-blogs. A blog is a type of website or part of a website, usually maintained by an individual with regular entries such as commentary, descriptions of events, graphics and video. A micro-blog is a passive broadcast medium in the form of blogging. A micro-blog is different than a blog in that its content is typically much smaller, in both actual size and aggregate file size. For example, a micro-blog entry could consist of nothing but a short sentence fragment, an image or embedded video.

The sponsored multi-media blogging technique, in one embodiment, is an advertising-driven service on a computing device, such as for example, a mobile phone, that makes a multi-media micro-blog or blog an effective carrier for advertising. The data collected while employing the sponsored multi-media blogging technique project can be used for user intent mining and increasing advertisement relevance for mobile advertising projects.

In one embodiment, the sponsored multi-media blogging technique supports automatic multi-media micro-blog/blog authoring. It uses a rich collection of templates for authoring personalized micro-blogs/blogs. In another embodiment, the sponsored multi-media blogging technique supports multi-media micro-blog/blog streaming for instant experience sharing between users without adding or embedding advertisements. In yet another embodiment the technique supports contextual advertising for mobile multi-media, which automatically associates the most relevant advertisements or services with a user's message context.

### DESCRIPTION OF THE DRAWINGS

The specific features, aspects, and advantages of the disclosure will become better understood with regard to the following description, appended claims, and accompanying drawings where:

FIG. 1 is an exemplary architecture for employing the sponsored multi-media blogging technique described herein.

FIG. 2 depicts a flow diagram of an exemplary process for employing the sponsored multi-media blogging technique.

FIG. 3 depicts a flow diagram of another exemplary process for employing the sponsored multi-media blogging technique.

FIG. 4 depicts a schematic of an exemplary process for creating a multi-media message in the form of a blog or micro-blog from unstructured recordings using templates according to one embodiment of the sponsored multi-media blogging technique.

FIG. 5 depicts a schematic of another exemplary embodiment of the sponsored multi-media blogging technique wherein the technique determines whether to create a blog or a micro-blog.

FIG. 6 is a schematic of an exemplary computing device which can be used to practice the sponsored multi-media blogging technique.

### DETAILED DESCRIPTION

In the following description of the sponsored multi-media blogging technique, reference is made to the accompanying drawings, which form a part thereof, and which show by way of illustration examples by which the sponsored multi-media blogging technique described herein may be practiced. It is to be understood that other embodiments may be utilized and structural changes may be made without departing from the scope of the claimed subject matter.

1.0 Sponsored Multi-Media Blogging Technique

The following sections provide an overview of the sponsored multi-media blogging technique, as well as an exemplary architecture and processes for employing the technique. Details of exemplary embodiments of the technique, as well as exemplary user scenarios, are also provided.

1.1 Overview of the Technique

Mobile computing devices such as mobile phones can provide a more natural and interactive way to determine user intent and to advertise online. This is in part because they can capture richer contextual information (e.g., buddy list, calendar, messages, locations, time, events, etc.) than the typical desktop computer. With more and more users using instant multi-media messaging (MMS) and blogging services on mobile phones, the sponsored multi-media blogging technique employs real time communication (for example, blogs or micro-blogs) as an effective information carrier for mobile advertising and for determining user intent. Through these instant multi-media messages (e.g., blogs or micro-blogs), in one embodiment the sponsored multi-media blogging technique delivers advertisements that are trusted, wanted, and needed by the user.

The sponsored multi-media blogging technique is inspired by the rich media dataflow through the SNSs, as well as the mobile phone. The sponsored multi-media blogging technique can employ rich media messages used for micro-blogging and normal blogging in sponsored multi-media blogging.

There is a lack of a convenient tool for authoring multi-media content in a similar way to text messages. The most popular micro-blogging site, Twitter®, is nothing but a real time Really Simple Syndication (RSS) feed with people subscribing to it. A key concept in the development of the sponsored multi-media blogging technique is the simplicity of real time messages regarding things that people care about. For example, if there is a blogger or micro-blogger who can always provide useful commercial messages that benefit the users, this blogger/micro-blogger will be credible just for valued commercials. However, blogs with commercial messages created by professional or sponsored bloggers may be suspiciously viewed and poorly received by many people.

In one embodiment, the sponsored multi-media blogging technique makes every blogger, blog and micro-blog a potential carrier for advertising. From this perspective, the sponsored multi-media blogging technique is able to monetize rich media blogs or micro-blogs while providing automatic multi-media blog or micro-blog authoring and instant sharing services. In other words, in this embodiment, each multi-media blog or micro-blog message is associated with a contextually relevant advertisement or a recommended valuable product or service.

The sponsored multi-media blogging technique in one embodiment supports automatic multi-media micro-blog/blog authoring. For example, the sponsored multi-media blogging technique can use a rich collection of templates for authoring personalized micro-blogs/blogs. Furthermore, the technique has different strategies for authoring blogs or micro blogs as will be discussed in greater detail later. The sponsored multi-media blogging technique can also support multi-media micro-blog/blog streaming for instant experience sharing between users.

It is notable that the sponsored multi-media blogging technique is not dedicated to any specific SNS. Instead, it represents a general service that supports sponsored mobile multi-media blogging/micro-blogging for any SNS.

A key advantage of the sponsored multi-media blogging technique, is that users do not need to worry about the tedious work involved in composing complex blogs/micro-blogs on a mobile phone. In one embodiment of the sponsored multi-media blogging technique, users also do not need to pay for the services provided by the sponsored multi-media blogging technique, such as multimodal micro-blog/blog input, automatic multi-media micro-blog/blog authoring, and instant messaging. In one embodiment of the sponsored multi-media blogging technique, part of the user's conversations or blogs using the sponsored multi-media blogging technique are associated with contextually relevant advertisements or recommended services. It is the advertiser (e.g., the sponsor) who pays for these services. The advertisements or services embedded in the micro-blog/blog are preferably relevant and valuable information such as, for example, weather forecasts, traffic conditions, coupons, travel routes, and so on, so that users who are using the sponsored multi-media blogging technique feel that the advertisements provided are useful. Moreover, the advertisements or services are preferably embedded in the least intrusive way, so that users may not feel that the advertisers are intruding in their online lives.

1.3 Exemplary Architecture.

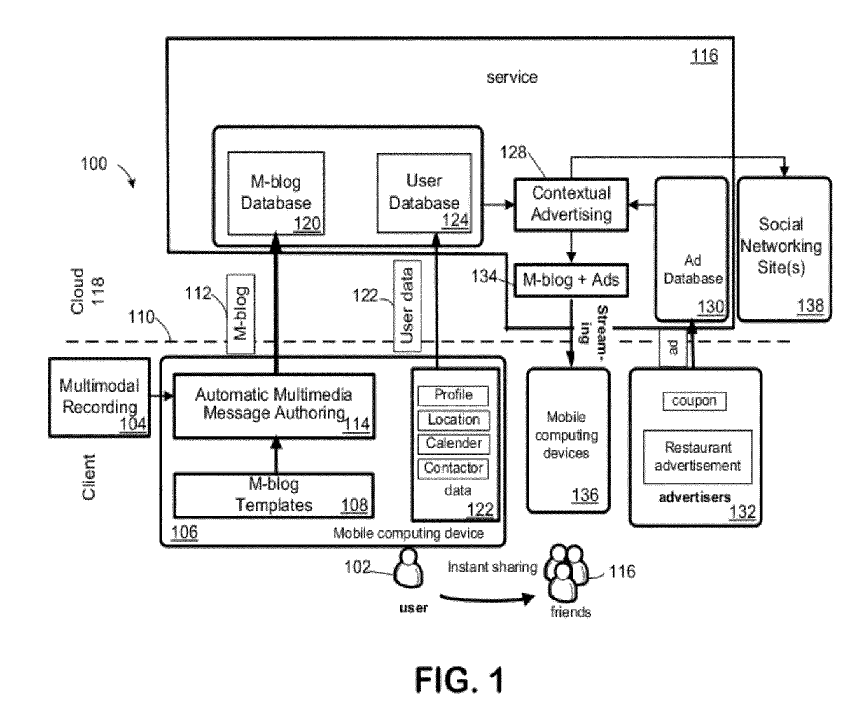

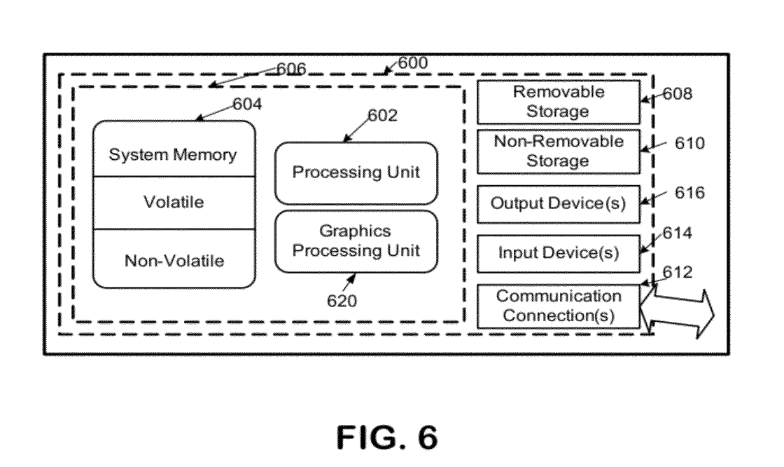

FIG. 1 shows an exemplary architecture 100 of one embodiment of the sponsored multi-media blogging technique. In this embodiment of the sponsored multi-media blogging technique, a user 102 can input text, capture an image or a video clip, or even speak to a mobile computing device 106, such as, for example, a mobile phone. This input data 104 is recorded. (A suitable computing device will be discussed in greater detail with respect to FIG. 6.) Typically this multimodal information 104 represents a real time user experience.

To automatically or semi-automatically and efficiently compose a multi-media message, in the form of a blog or micro-blog, for example, the sponsored multi-media blogging technique employs a collection of predetermined micro-blog or blog templates 108 for the captured diverse rich media content 104. These templates 108 can be stored on the user's mobile computing device 106 (e.g., mobile phone), as shown in FIG. 1, or can be accessed from a network 110 from a cloud 118. (The term “cloud” is used as a metaphor for the Internet, based on the cloud drawing used in the past to represent the telephone network, and later to depict the Internet in computer network diagrams as an abstraction of the underlying infrastructure it represents. In cloud computing applications are typically accessed over the Internet using a Web browser, while software and data are stored on servers.) The user 102 can select one of these templates 108 after capturing the multi-media data 104 or a template 108 can be selected automatically.

In one embodiment, through analysis of the recorded multi-media content and user data, the sponsored multi-media blogging technique is able to automatically detect the main topics (context) for the current blog/micro-blog 112 and select the most appropriate template 108 for authoring it. For example, the technique can match keyword metadata associated with the templates 108 to keywords in the multi-media content 104 or conversation (a thread or sequence of blogs or micro-blogs between users) and user data 122 to determine the context for the current micro-blog/blog. In one embodiment of the technique these actions of template selection are performed in the client (e.g., mobile phone or other computing device 106). In another embodiment, these actions are performed in the cloud 118 (e.g., a collection of servers, applications and databases on the Internet). Once appropriate templates 108 have been selected a multi-media blog 112 is created in an automatic multi-media authoring module 114 on the mobile computing device 106.

Once the blog/micro-blog 112 has been created, it is sent to a service 116 that can employ one or more servers, along with other user data 122 resident on the user's mobile computing device 106. The rich media micro-blog/blog 112 and user data 122 (such as, for example, user profile, current location, time, calendar, contact list) are uploaded to corresponding databases 120, 124 in the cloud 118. The blog/micro-blog 112 is stored in the blog/micro-blog database 120, while the user data 122 is stored in a user database. The micro-blog/blog data 120 and the user data 122 are used to match the context of the user's multi-media blog/micro-blog 112 with one or more advertisements in a contextual advertising module 128. More specifically, the contextual advertising module 128 interfaces with an advertisement database 130 and matches context of an advertisement in the advertisement database 130 with the context of the user's micro-blog/blog 112. In one embodiment the advertisement database 130 is filled with advertisements for products or services that are provided by advertisers 132. The contextual advertising module 128 is responsible for associating the uploaded multi-media micro-blog/blog 112 with the most contextually relevant advertisements. This can be done, for example, by taking the multi-media content for a multi-media message and user data (e.g., user data such as user profile, location, calendar and contacts) into consideration and matching this to the context of the advertisements (e.g., by using keywords, location, calendars, contacts and other criteria). The contextual advertising module can also be responsible for finding the least-intrusive location in the blog/micro-blog to embed the advertisements to create a sponsored multi-media blog or micro-blog 134. Then the sponsored micro-blog/blog 134 (i.e., the micro-blog/blog with the relevant ads or services embedded) will be streamed to the computing devices 136 of followers or friends 116 of the user 102. In this way, the user 102 can instantly share their experience with their friends 116.

The sponsored multi-media blogging technique not only supports instant messaging, but also in one embodiment provides a general automatic (micro) blogging service for any SNS 138. For example, one implementation of the sponsored multi-media blogging technique provides automatic micro-blog/blog authoring without adding advertisements. Another embodiment of the technique does not use the micro-blog/blog and user data databases to determine blog/micro-blog context, but provides automatic micro-blog/blog authoring and advertising to different SNSs. The micro-blogs/blogs and advertisements can be tailored to different styles of these sites (for example, micro-blogging for Twitter®, normal blogging for Windows® Live Spaces).

An exemplary architecture and variations thereof having been described, the following paragraphs provide a description of some exemplary processes for using the technique.

1.4 Exemplary Processes Employed by the Sponsored Multi-media Blogging Technique

The following paragraphs provide descriptions of exemplary processes for employing the sponsored multi-media blogging technique. It should be understood that in some cases the order of actions can be interchanged, and in some cases some of the actions may even be omitted.

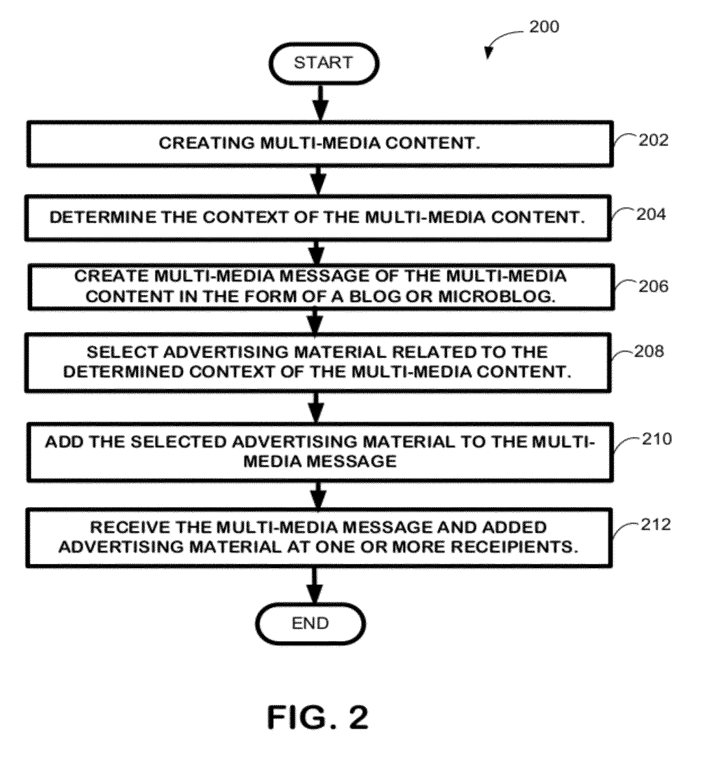

FIG. 2 depicts a computer-implemented process 200 for using one embodiment of the sponsored multi-media blogging technique to create multi-media blog messages. As shown in block 202, multi-media content is created. This multi-media content can be created by capturing it, for example, on a mobile computing device such as, for example a mobile phone. Or, for example, the multi-media content could be uploaded from another source. As shown in block 204, the context of the multi-media content is determined. For example the context can be determined by analyzing previous messages the user of the mobile device has sent or analyzing the present multi-media content. As shown in block 206, a multi-media blog message of the multi-media content is then created (for example, in the form of a blog or micro-blog). Advertising material related to the determined context of the multi-media content is then determined, as shown in block 208. For example, this can be done by comparing keywords attached to advertisements in an advertisement database to keywords found in the multi-media content and user data. The selected advertising material is then added to the multi-media blog message, as shown in block 210, and the multi-media message (e.g., in the form of a blog or micro-blog) with added advertising material is sent to one or more recipients, as shown in block 212.

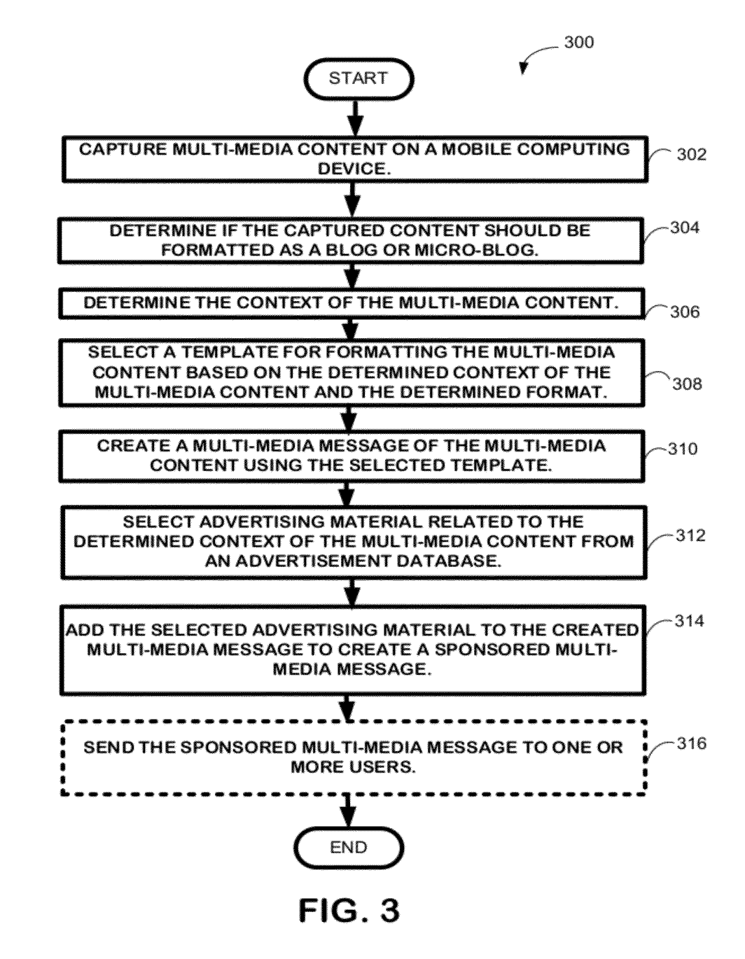

FIG. 3 provides a flow chart of another exemplary computer-implemented process for streaming advertisements in multi-media messages according to one embodiment of the sponsored multi-media blogging technique. As shown in block 302, multi-media content is captured on, or downloaded to, a mobile computing device, such as, for example a mobile phone. A decision is made as to whether the captured content should be formatted as a micro-blog or a regular blog format (also called a macro-blog), as shown in block 304. The context of the multi-media content is then determined, as shown in block 306. This can be done in one of many ways, such as by looking for keywords in the multi-media content or keywords in a thread/conversation the user of the mobile computing device is having with other users. As shown in block 308, a template for formatting the multi-media content is then selected based on the decision as to whether the captured content should be formatted as a micro-blog or blog and the context of the multi-media content. A multi-media message of the multi-media content using the selected template is created, as shown in block 310. Advertising material related to the determined context of the multi-media content from an advertisement database is then also selected, as shown in block 312. The selected advertising material is added to the created multi-media message to create a sponsored multi-media message (block 314). The sponsored multi-media message (e.g., in the form of a blog or micro-blog), with advertisement embedded or attached can then be sent to one or more users, as depicted in block 316.

It should be noted that although the above processes describe sending multi-media messages (e.g., blogs or micro-blogs) with advertising embedded or attached, the technique described herein can also be used to send micro-blog or blog messages without advertisements attached.

1.5 Creating a Multi-Media Blog/Micro-Blog

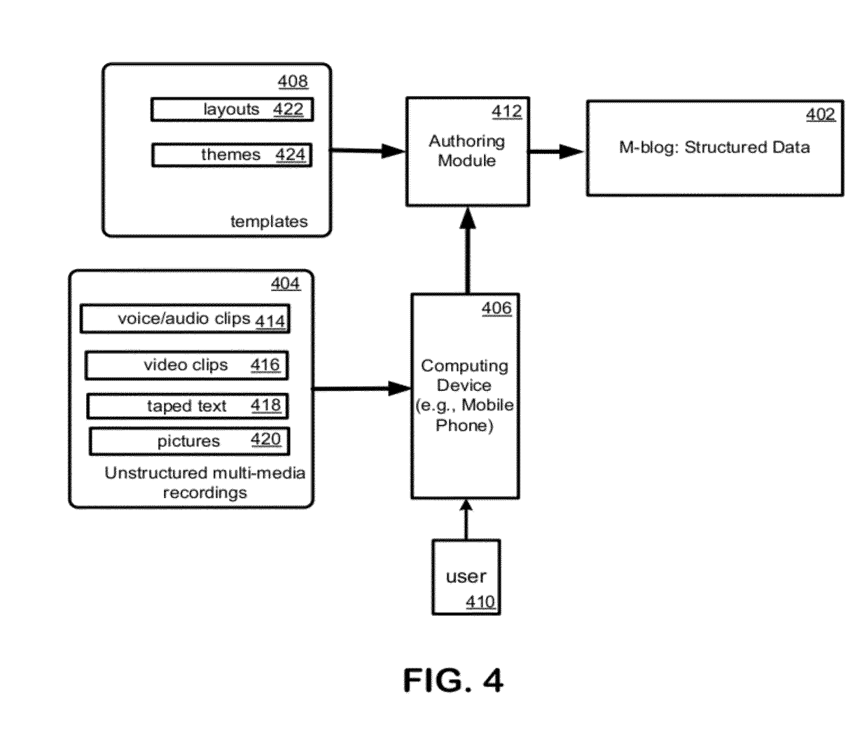

This following paragraphs and FIG. 4 provide a description of how one exemplary embodiment of the technique automatically (or interactively) generates a multi-media message in the form of a blog or micro-blog 402 from unstructured recordings 404 on a mobile computing device 406 via predefined templates 408.

The input into the mobile computing device (e.g., mobile phone) is a collection of multi-media recordings 404, such as, for example, taped text, pictures and video clips captured through a camera (e.g., a mobile phone camera), and voices or audio clips recorded through an embedded microphone in the mobile computing device or otherwise downloaded onto the mobile computing device. Media snippets 414, 416, 418,420 are collected as shown in block 404 and each snippet (e.g., a piece of text 418, a photo 420, a video/audio clip 418, 410 of the multi-media recordings 404) may be associated with rich context such as GPS location, timestamp (recording date and time), accelerometer parameters, and so on, obtained when the multi-media recordings were made. In one embodiment of the technique, a mobile phone user can decide when to author either a micro-blog each time he/she records something, or a blog (i.e., a normal blog containing multiple snippets) like a travel log on live space after he/she finishes recording a complex event. When authoring a blog/micro-blog, users can select a template from a collection of predefined templates 408 (themes 422 and layouts 422) or the system can automatically suggest the most appropriate template according to the event categories (e.g., travel, movie, arts, night-out events, vacation, etc.). The output is the organized multi-media blog or micro-blog 402 which can be, for example, distributed through any social network.

1.6 Determining Whether to Create a Multi-Media Blog/Micro-Blog

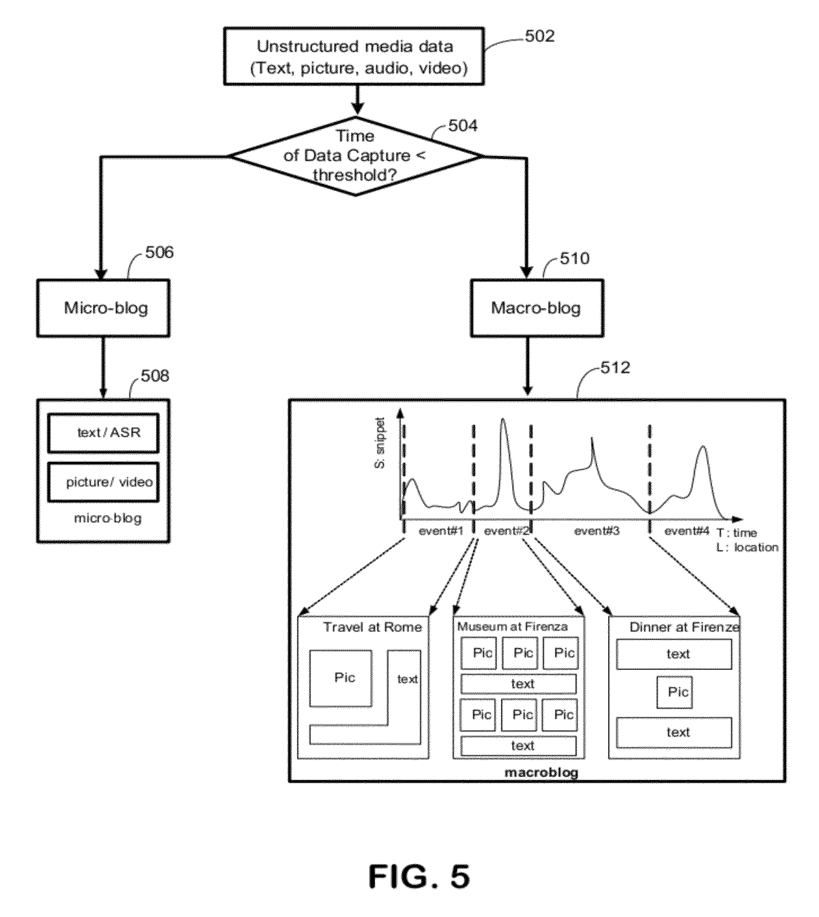

FIG. 5 shows the flowchart an exemplary embodiment of the technique for automatically determining whether to create a blog or micro-blog and then generating a multi-media blog or micro-blog based on this determination. In one embodiment, in order to generate a blog/micro-blog from input unstructured multi-media data (block 502), the technique classifies whether a user wants to post a micro-blog or a blog based on examining the capture time of the input multi-media data (block 504). As shown in blocks 504 and 506, if the duration (from the beginning of capture time to the end) is less than a given threshold Tₕ, then the technique assumes that the multi-media data should be structured as a micro-blog. If it is determined that a micro-blog should be created, then this implies that there is only one event in this blog. The technique then simply displays all the snippets as shown in block 510. In one embodiment, the text and automatic speech recognized (ASR) text are displayed before the pictures or video clips.

If it is determined that the multi-media data should be structured as a blog or a user wants to generate a complex blog, i.e., a macro-blog, the technique first segments all the media snippets into different events based on associated timestamp and location, as shown in block 512. The snippets captured in a close area or in a short period of time are assumed to belong to the same event. Note that the technique can obtain the associated timestamp and location (latitude and longitude) through the sensors embedded in mobile computing devices. If the technique tracks the user's trace (time stamp and location), it can even know user's status (i.e., working, driving, still, etc.). Based on user's location and status, the technique, in one embodiment, can automatically suggest the title of each event, (e.g, traveling at Rome, Visiting museum at Firenza, Dinner at XXX.) The technique can also select a blog template for specific event, as discussed previously. Each template has a set of predefined slots (text, picture, and video) and each snippet can be filled into a corresponding slot. As a result, in one embodiment, the macro-blog is a series of events arranged in terms of time.

2.0 Exemplary User Scenarios for Using the Sponsored Multi-media Blogging Technique

The following paragraphs provide two exemplary user scenarios on how the sponsored multi-media blogging technique can be used. The first scenario delineates the sharing of a travel experience with the technique, while the second scenario shows how the technique makes implicit product or service recommendations.

Scenario I: Jessica travels to Beijing. During her trip, a sponsored multi-media blogging application installed in her mobile phone helped her easily record many memorable experiences. She wrote down her thoughts on the mobile phone, took photos and videos of the “great wall” and “forbidden city,” and recorded her spoken thoughts and some Beijing operas. However, it was too difficult for her to properly organize the large amount of rich media data and compose a blog or message on the phone. But she found that that the sponsored multi-media blogging technique provided a set of beautiful and professional templates for multi-media messages, for example in the form of micro-blogs and blogs, as well as a suggested list of the most suitable templates based on what she had captured. The sponsored multi-media blogging technique automatically created a multi-media message based on her selected template. When she wanted to share her experience with her friends in the United States, the sponsored multi-media technique was able to stream the multi-media messages (or micro-blog or blog) to her friends' mobile phones through a 3G network and to recommend relevant services (such as the travel agents to Beijing in their cities). After receiving the sponsored MMS and reading the blog, her friends said that they thought her experience was great, that the micro-blog/blog looked beautiful, and finally that the recommended services were also valuable.

Scenario II: Jessica sent some multi-media messages to her best friend Emily through the sponsored multi-media blogging technique because the messaging service provided by the sponsored multi-media blogging technique was totally free. They talked about shopping. Jessica suggested going shopping in downtown Seattle that afternoon and sent this message to Emily. When Emily received it, she also found that there was a coupon for a restaurant in downtown Seattle and a weather tip showing that it was to be rainy in the afternoon. Emily then told Jessica that it was a good idea to go shopping first and then have a nice dinner in that restaurant, but not to forget to bring an umbrella. When Emily was shopping in a mall, she found a pair of shoes she liked. She knew that her sister Kathy also would like the shoes. She then captured a photo of the shoes using the sponsored multi-media blogging technique, and sent a multi-media message to her sister saying “Kathy, I think you will definitely like these shoes in the XXX mall” to her phone, and then sent the automatically generated micro-blog/blog (containing both photo and voice) to Kathy. When Kathy received this message, she also noticed that in addition to the original message, there was a list of coupons about the shoes and one of them in the YYY mall was cheaper than that in the XXX mall. She replied this message and told Emily that “it is better you buy these shoes in the YYY mall.”

3.0 The Computing Environment

The sponsored multi-media blogging technique is designed to operate in a computing environment. The following description is intended to provide a brief, general description of a suitable computing environment in which the sponsored multi-media blogging technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 6 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 6, an exemplary system for implementing the sponsored multi-media blogging technique includes a computing device, such as computing device 600. In its most basic configuration, computing device 600 typically includes at least one processing unit 602 and memory 604. Depending on the exact configuration and type of computing device, memory 604 may be volatile (such as RAM), non-volatile (such as ROM, flash memory, etc.) or some combination of the two. This most basic configuration is illustrated in FIG. 6 by dashed line 606. Additionally, device 600 may also have additional features/functionality. For example, device 600 may also include additional storage (removable and/or non-removable) including, but not limited to, magnetic or optical disks or tape. Such additional storage is illustrated in FIG. 6 by removable storage 608 and non-removable storage 610. Computer storage media includes volatile and nonvolatile, removable and non-removable media implemented in any method or technology for storage of information such as computer readable instructions, data structures, program modules or other data. Memory 604, removable storage 608 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cwebsitetes, magnetic tape, magnetic disk storage or other magnetic storage devices, or any other medium which can be used to store the desired information and which can accessed by device 600. Computer readable media include both transitory, propagating signals and computer (readable) storage media. Any such computer storage media may be part of device 600.

Device 600 also can contain communications connection(s) 612 that allow the device to communicate with other devices and networks. Communications connection(s) 612 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 600 may have various input device(s) 614 such as a display, keyboard, mouse, pen, camera, touch input device, and so on. Output device(s) 616 devices such as a display, speakers, a printer, and so on may also be included. All of these devices are well known in the art and need not be discussed at length here.

The sponsored multi-media blogging technique may be described in the general context of computer-executable instructions, such as program modules, being executed by a computing device. Generally, program modules include routines, programs, objects, components, data structures, and so on, that perform particular tasks or implement particular abstract data types. The sponsored multi-media blogging technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for streaming advertisements in multi-media blog messages, comprising:
(a) creating multi-media content;
(b) determining the context of the multi-media content;
(c) creating a multi-media blog message of the multi-media content;
(d) selecting advertising material related to the determined context of the multi-media content;
(e) adding the selected advertising material to the multi-media blog message; and
(f) receiving the multi-media message with added advertising material at one or more recipients.

2. The computer-implemented process of claim 1, further comprising using the determined context of the multi-media content to select context-specific templates to create the multi-media blog message.

3. The computer-implemented process of claim 1 wherein the multi-media blog message is a micro-blog.

4. The computer-implemented process of claim 1, wherein the multi-media content is captured on a mobile phone.

5. The computer-implemented process of claim 1, wherein the advertising material is added after the multi-media blog message is created to create the multi-media blog message with added advertising material.

6. A system for automatically streaming multi-media messages from a user, comprising:
a general purpose computing device;
a computer program comprising program modules executable by the general purpose computing device, wherein the computing device is directed by the program modules of the computer program to,
(a) create multi-media content;
(b) determine the context of the multi-media content;
(c) select a template based on the context of the multi-media content from a group of predetermined templates;
(d) create a multi-media message of the multi-media content using the selected template; and
(e) send the multi-media message to one or more recipients.

7. The system of claim 6, further comprising modules to:
select advertising material related to the determined context of the multi-media content;
add the advertising material to the multi-media message after sending the multi-media message, but before the multi-media message is received at the one or more recipients.

8. The system of claim 6, wherein the context of the multi-media message is determined by using conversation data between users.

9. The system of claim 6, wherein the context of the multi-media message is determined using user data of several users.

10. The system of claim 7, wherein the selected advertising material is selected from an advertisement database.

11. The system of claim 6, wherein context of the multi-media message is determined using users' location data.

12. The system of claim 7, further comprising a module for selecting advertising material based partially on location data.

13. The system of claim 7, further comprising a module for selecting advertising material based partially on a user's calendar data.

14. The system of claim 6 wherein multiple multi-media messages are created and streamed to one or more recipients.

15. A computer-implemented process for streaming advertisements in multi-media messages, comprising:
(a) capturing multi-media content on a mobile computing device;
(b) determining if the multi-media content should be formatted in the form of a blog or a micro-blog;
(b) determining the context of the multi-media content;
(c) selecting a template for formatting the multi-media content based on the determined context of the multi-media content and the determination of whether the content should be formatted as a blog or micro-blog;
(d) creating a multi-media message of the multi-media content using the selected template;
(e) selecting advertising material related to the determined context of the multi-media content from an advertisement database;
(f) adding the selected advertising material to the created multi-media message to create a sponsored multi-media message.

16. The computer-implemented process of claim 15, further comprising the process action of receiving the sponsored multi-media message at one or more recipients.

17. The computer-implemented process of claim 15 wherein the context of the multi-media content is determined from conversation data between users, and wherein key words in the users' conversation data are used to determine the context of the multi-media content.

18. The computer-implemented process of claim 15 wherein the context of the multi-media content is determined from conversation data between users, and wherein key words in the user's conversation data are matched to keywords in advertisements in the advertisement database to select advertisement material.

19. The system of claim 15 wherein the determination of whether the multi-media content should be formatted as a blog or micro-blog is made based on the capture time of the multi-media content.

20. The system of claim 19 wherein the multi-media content is formatted as a micro-blog if the capture time is below a given threshold.
